(19) United States
(12) Patent Application Publication
(10) Pub. No.: US 2014/0050813 A1
(43) Pub. Date: Feb. 20, 2014

(54) Edge Seal on a Vacuum Bag Used in an Infusion Molding Process

(71) Applicant: Salvador Chava Balas, Jupiter, FL (US)

(72) Inventor: Salvador Chava Balas, Jupiter, FL (US)

(21) Appl. No.: 13/943,239

(22) Filed: Jul. 16, 2013

Related U.S. Application Data
(60) Provisional application No. 61/683,982, filed on Aug. 16, 2012.
(60) Provisional application No. 61/794,388, filed on Mar. 15, 2013.

(51) Int. Cl. B29D 99/00

(52) U.S. Cl. CPC B29D 99/0053
USPC 425/388

(57) ABSTRACT

A seal is provided on a vacuum bag used in an infusion molding process. The seal is a truncated V-shape that has convergent walls and a distal end that defines a vacuum channel in conjunction with an infusion mold.

### CROSS-REFERENCE TO RELATED APPLICATIONS

This application the benefit of U.S. provisional Application No. 61/683,982 filed Aug. 16, 2012 and U.S. provisional Application No. 61/794,388 filed Mar. 15, 2013, the disclosures of which are incorporated in their entirety by reference herein.

### TECHNICAL FIELD

This application relates to an edge seal for a vacuum bag and the vacuum bag made with the edge seal for use in an infusion molding process.

### BACKGROUND

Vacuum bag seals are provided on vacuum bags used in an infusion molding process that uses a flexible film, or bag, to enclose a part. A vacuum is drawn on the vacuum bag on one side of the part and atmospheric pressure compresses the part from the other side during a curing step. Vacuum bags used in vacuum bag molding processes may be provided in either a tube shape or sheet form.

Seals at the edges of the vacuum bag form a seal against the edges of the mold surface to enclose the part in an air-tight mold. The lower mold is a rigid structure and the upper surface of the part is formed by the vacuum bag that forms a flexible membrane. The body of the vacuum bag may be a reusable silicone material or an extruded polymer film. A vacuum is drawn on the part and held while the part is cured.

The vacuum bag is a bag made of a strong elastomer coated fabric or a polymer film of sufficient thickness to compress the part during a curing or hardening step. Vacuum is applied to the parts during curing on one side with a uniform pressure of approximately one atmosphere being applied to the parts through the vacuum bag.

Vacuum bagging is widely used in the composites industry. Carbon fiber fabric and fiberglass fabric may be infused with resins or epoxies in a vacuum bagging operation. Infusion molding is used to transfer resin from one area of a part being manufactured to another area. Infusion molding also may be used to consolidate laminated layers by removing entrapped air. The vacuum bag, as previously described, may be used to form a vacuum chamber in combination with a mold. Atmospheric pressure applied to the vacuum bag compresses the laminated composite part as the resin cures.

Several processes may be used to manufacture a bag suitable for use in an infusion molding operation. A reusable polymer bag may be manufactured by spraying, swirl spraying, SWORL™ spraying, or brush application of one or more layers of a polymeric material over the mold.

One problem encountered with vacuum bag seals is that the seals may not provide sufficient clearance to draw a vacuum evenly under the vacuum bag when resin is infused into a fiber reinforcement. Resin movement may be blocked in areas where the bag impinges upon the mold. Some of the resin may flow non-uniformly and may reach the mold edge before resin in other portions of the mold reach the mold edge. Non-uniform resin flow may block the narrow passages located between the mold edge and the bag.

The seals may become detached from the mold while manufacturing parts using an infusion molding process because the vacuum bag may conform to the part to an extent that drawing a vacuum becomes difficult. Another problem is that air may become entrapped between a reusable vacuum bag and the part that reduces the pressure on the part.

This disclosure is directed to solving one or more of the above problems and other problems as summarized below.

### SUMMARY

According to one aspect of this disclosure, a seal is provided on an edge of a vacuum bag used in an infusion molding process with a mold having a groove formed by two converging walls in or on a mold flange that define a seal receptacle. The seal comprises a seal body molded onto the edge of the vacuum bag. The seal has an inner surface extending from the vacuum bag edge in one direction and an outer surface extending from the vacuum bag edge in the one direction. The inner surface and the outer surface converge as they extend away from the vacuum bag edge. A distal end surface extends between the inner surface and the outer surface at a spaced location relative to the vacuum bag edge. The distal end surface partially defines a vacuum channel inside the two converging walls of the mold flange.

According to another aspect of this disclosure relating to the seal, an outboard wall may define a groove at a spaced location relative to the vacuum bag edge. The vacuum bag may include a rib that is inserted in the groove to retain the vacuum bag on the mold.

According to another aspect of this disclosure relating to the seal, the inner surface may define an inner wall groove and the outer surface may define an outer wall groove. The inner wall groove and the outer wall groove function to retain the seal in the seal profile when the seal is molded onto the vacuum bag.

According to another aspect of this disclosure relating to the seal, the distal end surface may be a convex surface, concave surface, or a flat surface.

According to another aspect of this disclosure a vacuum bag is provided for an infusion molding process using a mold that has a seal receiving V-shaped groove on a mold flange. The vacuum bag comprises a flexible layer of material that is substantially impervious to air and that has a peripheral edge. A seal is attached to the peripheral edge that extends around the flexible layer of material and is a truncated V-shaped member that is truncated at the point. The truncated V-shaped member defines a vacuum cavity in the V-shaped groove of the mold.

According to another aspect of this disclosure relating to the vacuum bag, the V-shaped groove of the mold has an inner wall and an outer wall that are integral with a flange of the mold and converge toward the depth of the V-shaped groove. The seal may include a first sealing surface and a second sealing surface that engage part of the inner wall and the outer wall. A distal end surface is provided on the seal that extends between the first sealing surface and the second sealing surface.

According to another aspect of this disclosure relating to a vacuum bag, the distal end surface may be concave, convex, or flat.

According to other aspects of this disclosure relating to a vacuum bag, at least one of the inner wall and the outer wall may be provided with a recess. At least one of the first sealing surface and the second sealing surface may be provided with a protrusion that is received in the recess in the inner wall and the outer wall when the seal is inserted into the V-shaped groove. The recess may be a V-shaped notch and the protrusion may be a V-shaped rib. The recess may be a semi-cylindrical shaped notch and the protrusion may be a semi-cylindrical rib.

According to other aspects of this disclosure relating to a vacuum bag, a bag lock rib may be formed on the flexible layer outboard of the seal that is adapted to be received in a bag lock groove in the mold outboard of the V-shaped groove in the mold. The groove in the mold may be a V-shaped notch and the bag lock rib may be a V-shaped rib. The groove in the mold may be a semi-cylindrical shaped notch and the bag lock rib may be a semi-cylindrical rib.

According to another aspect of this disclosure, an elongated seal profile is provided for forming a vacuum bag including a seal that extends along a peripheral portion of the vacuum bag used with an infusion mold. The seal profile comprises an inner wall and an outer wall. The inner wall is associated with a flange and has an inner seal forming face and an inner filler engaging face. The outer wall is associated with the flange and has an outer seal forming face that is spaced from the inner seal forming face. A seal forming cavity is defined by the inner seal forming face and the outer seal forming face. A filler may be disposed in the seal profile in engagement with the inner filler engaging face and the outer seal engaging face when the seal is molded onto the vacuum bag between the inner wall and the outer wall.

According to another aspect of this disclosure regarding the seal profile, the inner wall and the outer wall may each include a lip that over hangs the filler when the seal is molded onto the vacuum bag.

According to another aspect of this disclosure regarding the seal profile, the outer wall may define a groove at a spaced location relative to the flange and wherein the vacuum bag may include a rib that is inserted in the groove to retain the bag on the infusion mold.

According to another aspect of this disclosure regarding the seal profile, the inner wall may define an inner wall groove in the inner seal forming face and the outer wall may define an outer wall groove in the outer seal forming face. The inner wall groove and the outer wall groove function to retain the seal in the seal profile when the seal is molded onto the vacuum bag.

The above aspects and other aspects of this disclosure will be described in greater detail below with reference to the attached drawings.

### BRIEF DESCRIPTION OF THE DRAWINGS

FIG. 1 is a fragmentary perspective view of a seal profile that is used to make a mold that is, in turn, used to make vacuum bags for an infusion mold.

FIG. 2 is a fragmentary perspective view of a filler that is inserted in the mold to make the vacuum bag.

FIG. 3 is a fragmentary perspective view of an alternative embodiment of a seal profile.

FIG. 4 is a perspective view partially in cross section of a seal profile attached to a flange for forming a mold that is, in turn, used to make the vacuum bag.

FIGS. 5a-5e are cross-sectional views of a method of making a mold for a vacuum bag and for making the vacuum bag.

FIG. 6 is a fragmentary cross-sectional view of a vacuum bag attached to an infusion mold.

FIG. 7 is a fragmentary cross-sectional view of an infusion mold with a retrofit base seal that has a vacuum bag having a V-shaped bag retention rib that is received in a U-shaped groove when the vacuum bag is assembled over the mold and mold cavity.

FIG. 7a1 is a close-up view of an alternative embodiment of a semi-cylindrical bag retention rib that is received in a semi-cylindrical groove.

FIG. 7a2 is a close-up view taken from the circle “a” in FIG. 7 of a rectangular bag retention rib that is received in a rectangular groove.

FIG. 7b1 is a close-up view taken in the circle “b” showing a V-shaped bag retention rib received in a U-shaped groove.

FIG. 7b2 is an enlarged cross-sectional view taken in circle “b” in FIG. 7 showing a rectangular bag retention rib received in a rectangular groove.

FIG. 8 is a fragmentary cross-sectional view of an infusion mold with a retrofit seal receptacle that has a vacuum bag including a bag seal with a flat distal end.

FIG. 8c1 is an enlarged cross-sectional view taken in the circle “c” in FIG. 8 showing a concave distal end.

FIG. 8c2 is a cross-sectional view taken in the circle “c” in FIG. 8 showing a seal with a convex distal end.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but as a representative basis for teaching one skilled in the art how to practice the disclosed concepts. References to chemical compositions and materials are to the presently preferred compositions and it should be understood that other materials and compositions may be used.

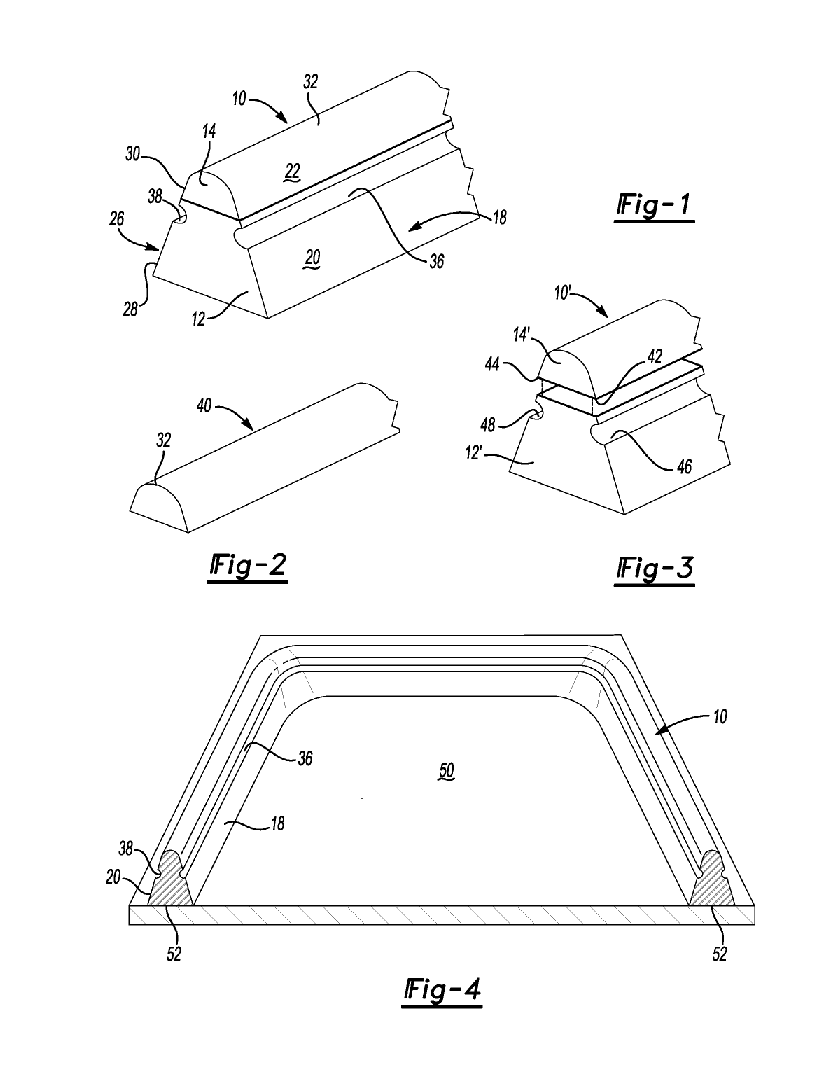

Referring to FIG. 1, a seal profile 10 is illustrated that includes a seal forming portion 12 and a filler forming portion 14. An inner wall 18 of the seal profile 10 includes an inner seal forming face 20 and an inner filler forming face 22. An outer wall 26 includes an outer seal forming face 28 and an outer filler forming face 30. The upper portion, as illustrated, of the seal profile 10 forms an arcuate apex 32. It should be understood that the arcuate apex 32 may be more broadly arcuate or may form a relatively sharp edge.

An inner semi-cylindrical groove 36 and an outer semi-cylindrical groove 38 are formed on the inner seal forming face 20 of the inner wall 18 and the outer seal forming face 28 of the outer wall 26, respectively. The semi-cylindrical grooves 36, 38 are used to form ribs in the mold that function to retain the seal when formed and during a molding operation in the seal profile, as will be described in greater detail below.

Referring to FIG. 2, a filler 40 is illustrated that is used to fill an area in the mold corresponding to the arcuate apex 32 shown in FIG. 1. The filler 40 may be separate piece or may be detachably attached as the filler forming portion 14 to the seal forming portion 12 of the seal profile 10 shown in FIG. 1.

Alternatively, the seal profile 10 can be formed in one piece and a separate piece similar to the filler 40 can be provide in a two piece kit.

Referring to FIG. 3, an alternative embodiment of a seal profile 10′ is illustrated that includes a seal forming portion 12′ and a filler forming portion 14′. The alternative embodiment of the seal profile 10 includes a filler forming portion 14′ that has an inner extension 42 and an outer extension 44 that are wider than the top of the seal forming portion 14′. An inner V groove 46 and an outer V groove 48 are provided on the seal profile 10′ instead of the inner semi-cylindrical groove 36 and outer semi-cylindrical groove 38 that are shown in FIG. 1. The inner extension 42 and outer extension 44 are provided to retain the filler 14′ in place in the vacuum bag mold when the vacuum bag is formed in the vacuum bag mold. When the seal is removed from the seal profile 10′, the filler 14′ remains in the mold.

Referring to FIG. 4, a seal profile 10 is shown attached to a flange 50. The seal profile 10 includes an attachment surface 52 that functions to attach the seal 10 to the flange 50. The seal profile includes an inner wall 18 and an outer wall 26. An inner semi-cylindrical groove 36 and an outer semi-cylindrical groove 38 are provided in the inner wall 18 and outer wall 26, respectively. As shown in FIG. 4, the seal profile 10 and flange 50 are ready to be used to form a mold for a vacuum bag. The process of forming the mold for the vacuum bag and forming the vacuum bag is described in greater detail below.

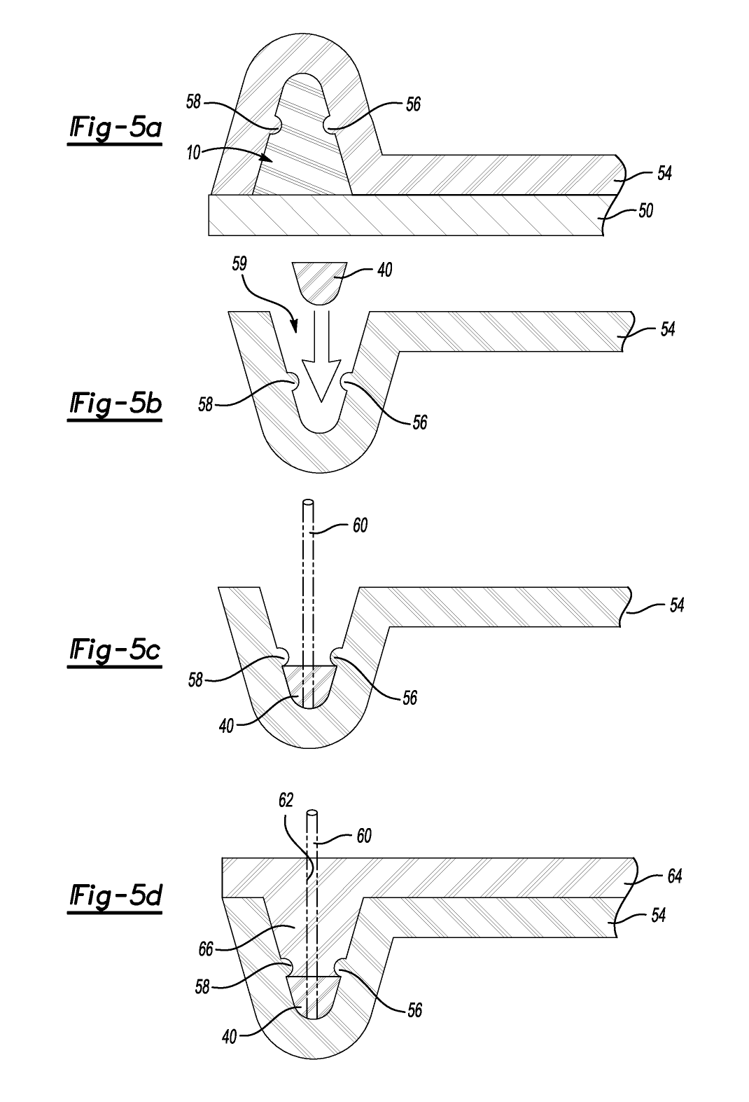

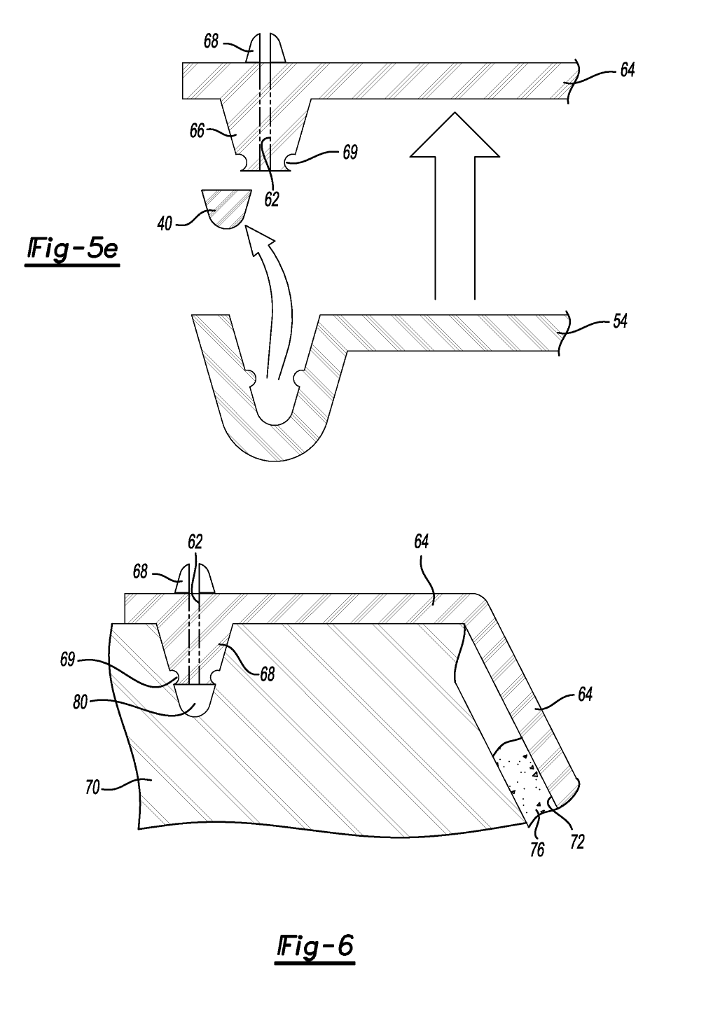

Referring to FIGS. 5a-5e, the process for forming the vacuum bag mold and then forming the vacuum bag using the mold is described. Referring specifically to FIG. 5a, seal profile 10 is shown attached to the flange 50. A vacuum bag mold 54 is formed by brushing, spraying, SWORL™ forming, pouring or laminating fiberglass type materials, or the like. The vacuum bag mold 54 may be formed from fiberglass or fiber reinforced composites, pre-preg materials, epoxy, ester based resins, metal, foam and polymer materials. An inner mold rib 56 and an outer mold rib 58 are formed on opposite sides of the seal profile 10.

Referring to FIG. 5b, the vacuum bag mold 54 is inverted as compared to the orientation shown in FIG. 5a and a filler 40 is inserted between and below the inner mold rib 56 and outer mold rib 58. The filler 40 is used to prevent the material used to form the vacuum bag from filling a portion of the V-shaped recess 59 of the vacuum bag mold 54.

Referring to FIG. 5c, a vacuum bag mold 54 is shown with the filler 40. A pin 60 may be attached to the vacuum bag mold 54 and through the filler 40.

Referring to FIG. 5d, the vacuum bag 64 is shown to be formed with a bag seal 66. The bag seal 66 and filler 40 define a vacuum opening 62 through the bag seal 66 of the vacuum bag 64. One or more pins 60 may be inserted in the filler 40 to provide a vacuum opening 62 through the bag seal 66.

Referring to FIG. 5e, the vacuum bag 64 is shown being separated from the vacuum bag mold 54 by the diagrammatic arrow. The filler 40 is also removed from the vacuum bag mold 54. The vacuum bag 64 includes an integrally formed bag seal 66. The bag seal 66 defines a vacuum opening 62. A vacuum port 68 may be laminated to the vacuum bag 64 that is in fluid flow communication with the vacuum opening 62. A semi-cylindrical seal retention groove 69 may be provided on one or both sides of the bag seal 66. The seal retention grooves 69 are used to retain the seal on the infusion molding die as will be described with reference to FIG. 6 below. The filler 40 fills the lower portion of the vacuum bag mold 54 to provide a vacuum channel, as is described below.

Referring to FIG. 6, an infusion mold 70 is shown with vacuum bag 64 assembled to the infusion mold 70. Infusion mold 70 includes a mold cavity 72 that is filled with a fiber reinforcement 74 and a resin 76. Vacuum is drawn through the vacuum channel 80 to retain the bag seal 66 on the infusion mold 70 by the force of a vacuum source connected to the vacuum channel 80. The vacuum channel 80 is connected to a source of vacuum through the vacuum opening 62 and vacuum port 68. The vacuum is also drawn through the infusion mold 70 from the mold cavity 72. During the infusion molding process, the bag seal 66 is held to the infusion mold 70. The vacuum bag 64 is applied over the mold cavity 72 and retains the fiber reinforcement 74 while resin 76 is injected into the mold cavity 72. The atmospheric pressure and vacuum provided to the mold cavity 72 to the infusion mold 70 compresses the resin 76 and fiber reinforcement 74 against the mold cavity 72 to form a part.

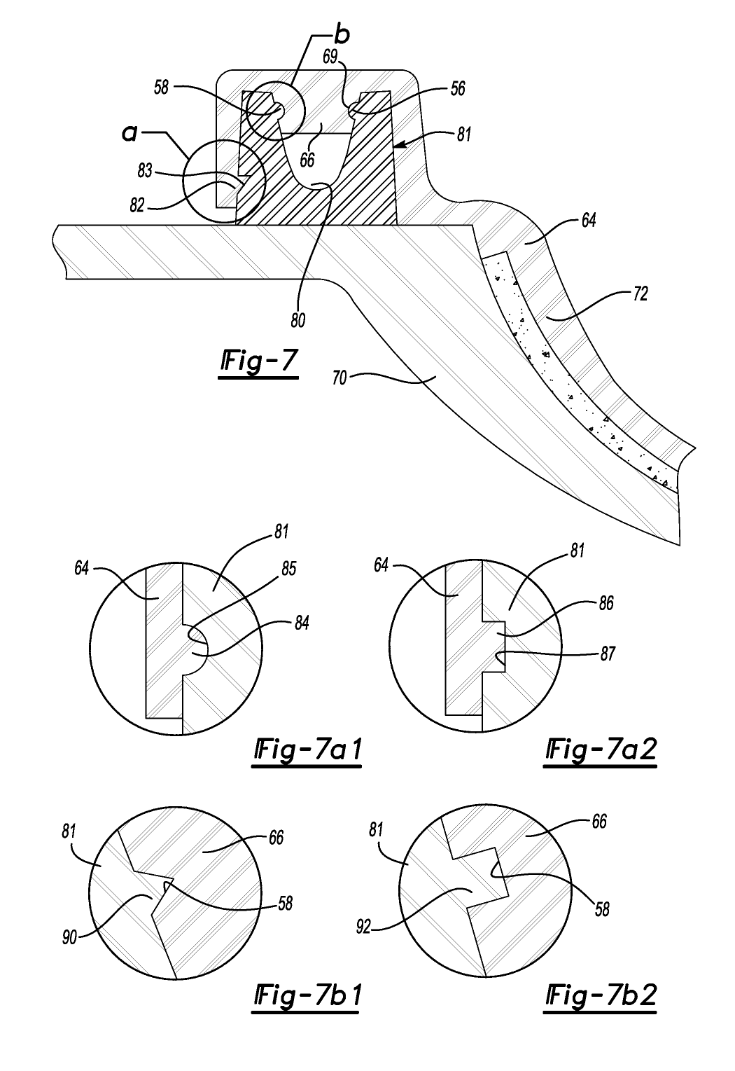

Referring to FIG. 7, an alternative embodiment of a vacuum bag 64 and infusion mold 70 is shown. The vacuum bag 64 is assembled to a retrofit seal 81 that is attached to the infusion mold 70, as previously described with reference to FIG. 6. A V-shaped bag retention rib 82 is provided on the outer edge of the vacuum bag 64 and is received in a V-shaped groove 83 formed in the retrofit seal 81 to facilitate holding the vacuum bag 64 on the infusion mold 70 with the bag seal 66. The bag seal 66 is retained by the inner seal rib 56 and outer seal rib 58. A semi-cylindrical bag retention groove 69 receives one of the inner seal ribs 56 or outer seal ribs 58. The combination of the bag seal 66 closes the vacuum channel 80. Also as shown in FIG. 7, the retrofit seal 81 that is attached to the mold 70 receives the bag seal 66 is retrofit to an existing mold flange portion of the mold 70.

Referring to FIG. 7a1, an alternative embodiment is shown in which a semi-cylindrical bag retention rib 84 is formed on the vacuum bag 64 and received in a semi-cylindrical groove 85 formed in the retrofit seal 81. In another alternative embodiment shown in FIG. 7a2, a rectangular bag retention rib 86 is formed with the vacuum bag 64 that is configured to be received in a rectangular groove 87 formed in the retrofit seal 81.

Referring to FIG. 7b1, a V-shaped bag protrusion feature 90 is formed on the bag seal 66. An inner bag groove 58 receives the V-shaped bag protrusion feature 90 to hold the seal in place during the infusion molding process. Referring to FIG. 7b2, a rectangular bag protrusion feature 92 is formed on the bag seal 66 that is received in the inner bag groove 58 that is similarly shaped to retain the bag seal 66 during the infusion molding process.

Referring to 8, another alternative embodiment of the vacuum bag 64 and bag seal 66 are illustrated as they are attached to the infusion mold 70. The vacuum bag covers the mold cavity 72, as previously described. The vacuum bag 64 includes the bag seal 66 that includes a flat distal end 93 that extends between the inner wall 18 and the outer wall 26. The vacuum channel 80 is defined by the walls 18 and 26 and the flat distal end 93 of the vacuum bag 64. The vacuum channel 80 is formed by a filler 40 that is inserted in the retrofit seal 81, as previously described with reference to FIGS. 5b-5e.

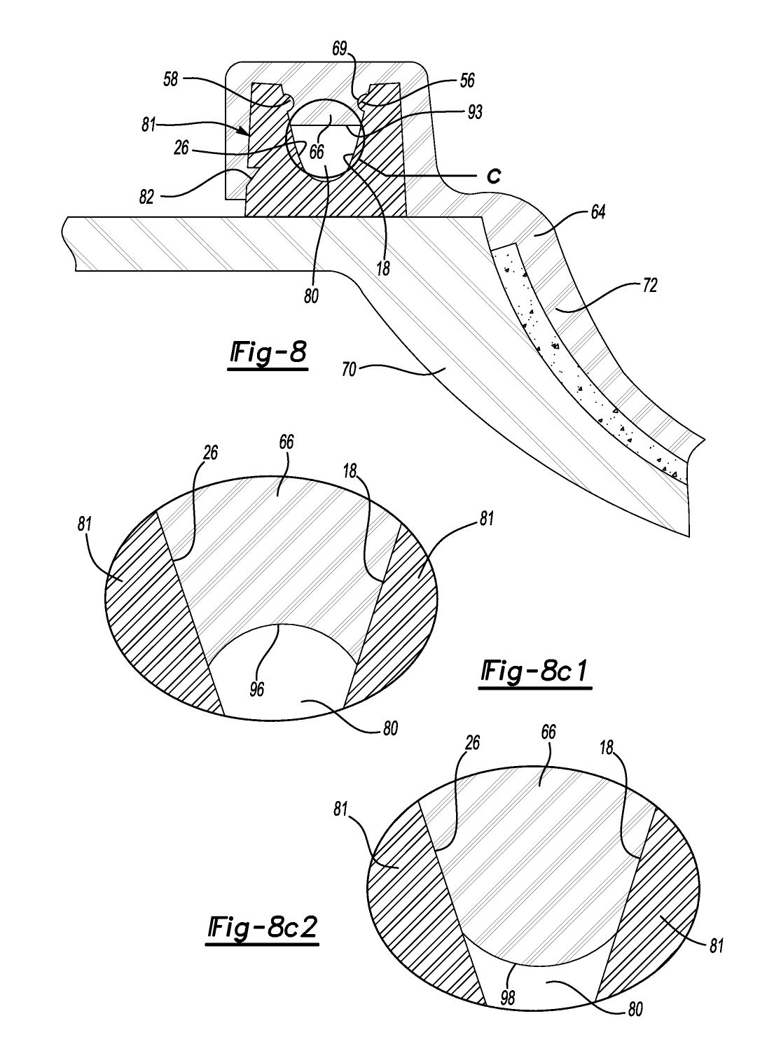

Referring to FIG. 8c1, another alternative embodiment is shown wherein a concave distal end 96 is provided on bag seal 66. The concave distal end 96 extends between the inner wall 18 and outer wall 26 to define the vacuum channel 80. Referring to FIG. 8c2, another alternative embodiment of the bag seal 66 is shown that has a convex distal end 98. The convex distal end 98 of the bag seal 66 cooperates with the inner wall 18 and outer wall 26 to form the vacuum channel 80.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seal formed on an edge of a vacuum bag used in an infusion molding process with a mold having a groove formed by two converging walls on a mold flange that define a seal receptacle, the seal comprising:
a seal body molded onto the edge of the vacuum bag that has:
an inner surface extending from the vacuum bag edge in one direction,
an outer surface extending from the vacuum bag edge in the one direction, wherein the inner surface and the outer surface converge as they extend away from the vacuum bag edge; and
a distal end surface extending between the inner surface and the outer surface at a spaced location relative to the vacuum bag edge, wherein the distal end surface defines a vacuum channel inside the two converging walls of the mold flange.

2. The seal of claim 1 wherein an outer wall defines a groove at a spaced location relative to the vacuum bag edge and wherein the vacuum bag includes a rib that is inserted in the groove to retain the vacuum bag on the mold.

3. The seal profile of claim 1 wherein the inner surface defines an inner wall groove and the outer surface defines an outer wall groove, wherein the inner wall groove and the outer wall groove function to retain the seal in the seal profile when the seal is molded onto the vacuum bag.

4. The seal of claim 1 wherein the distal end surface is selected from the group consisting of:
a convex surface;
a concave surface; and
a flat surface.

5. The seal of claim 1 wherein the seal defines a vacuum port opening that extends through the seal body from the distal end surface through the edge of the vacuum bag.

6. A vacuum bag for an infusion molding process using a mold that has a seal receiving V-shaped groove on a mold flange comprising:
a flexible layer of material that is impervious to air and that has a peripheral edge;
a seal attached to the peripheral edge that extends around the flexible layer of material and that is a truncated V-shaped member, wherein the truncated V-shaped member defines a vacuum cavity in the V-shaped groove of the mold.

7. The vacuum bag of claim 6 wherein the V-shaped groove of the mold has an inner wall and an outer wall that are formed in a flange of the mold and that converge toward the depth of the V-shaped groove, wherein the seal includes a first sealing surface and a second sealing surface that engage part of the inner wall and the outer wall, and wherein a distal end surface is provided on the seal that extends between the first sealing surface and the second sealing surface.

8. The vacuum bag of claim 7 wherein the distal end surface is selected from the group consisting of:
a convex surface;
a concave surface; and
a flat surface.

9. The vacuum bag of claim 7 wherein at least one of the inner wall and the outer wall are provided with a recess, and wherein at least one of the first sealing surface and the second sealing surface are provided with a protrusion that is received in the recess in the inner wall and the outer wall when the seal is inserted into the V-shaped groove.

10. The vacuum bag of claim 9 wherein the recess is a V-shaped notch and the protrusion is a V-shaped rib.

11. The vacuum bag of claim 9 wherein the recess is a semi-cylindrical shaped notch and the protrusion is a semi-cylindrical rib.

12. The vacuum bag of claim 6 further comprising a bag lock rib formed on the flexible layer outboard of the seal that is adapted to be received in a bag lock groove in the mold outboard of the V-shaped groove in the mold.

13. The vacuum bag of claim 12 wherein the groove in the mold is a V-shaped notch and the bag lock rib is a V-shaped rib.

14. The vacuum bag of claim 12 wherein the groove in the mold is a semi-cylindrical shaped notch and the bag lock rib is a semi-cylindrical rib.

15. An elongated seal profile for forming a vacuum bag including a seal that extends along a peripheral portion of the vacuum bag used with an infusion mold, the seal profile comprising:
an inner wall attachable to a flange that has an inner seal forming face and an inner filler engaging face;
an outer wall attachable to the flange that has an outer seal forming face that is spaced from the inner seal forming face that defines a seal forming cavity with the inner seal forming face and an outer seal forming face; and
a filler disposed in the seal profile in engagement with the inner filler engaging face and the outer filler engaging face when the seal is molded onto the vacuum bag between the inner wall and the outer wall.

16. The seal profile of claim 15 wherein the inner wall and the outer wall each include a lip that over hangs the filler when the seal is molded onto the vacuum bag.

17. The seal profile of claim 15 wherein the outer wall defines a groove at a spaced location relative to the flange and wherein the vacuum bag includes a rib that is inserted in the groove to retain the bag on the infusion mold.

18. The seal profile of claim 15 wherein the inner wall defines an inner wall groove in the inner seal forming face and the outer wall defines an outer wall groove in the outer seal forming face, wherein the inner wall groove and the outer wall groove function to retain the seal in the seal profile when the seal is molded onto the vacuum bag.
